(19) United States
(12) Patent Application Publication
(10) Pub. No.: US 2008/0282192 A1
(43) Pub. Date: Nov. 13, 2008

(54) METHOD AND APPARATUS FOR SELECTING AND DISPLAYING A NUMBER OF TEST DATA ITEMS

(76) Inventors: Kristin Petersen, Clifton Park, NY (US); Carli Connally, Fort Collins, CO (US)

Correspondence Address: Gregory W. Osterloth;Holland & Hart, LLP, P.O. Box 8749, Denver, CO, 80201, US

(21) Appl. No.: 11/745,396

(22) Filed: May 7, 2007

(51) Int. Cl. G06F 3/048

(52) U.S. Cl. 715/825; 715/810

(57) ABSTRACT

In one embodiment, a user-operable mechanism or selecting a number of tests in a test program is displayed via a graphical user interface (GUI). In response to a selected number of tests, a first plurality of test data items are filtered to obtain a number of test data items associated with the selected number of tests. The number of test data items associated with the selected number of tests is displayed via the GUI. Other embodiments are also disclosed.

### BACKGROUND

When testing circuit devices such as system-on-a-chip (SOC) devices, a graphical user interface (GUI) for displaying test results typically displays test results for all executed tests. Thus, if a user wants to limit the number of test results that are displayed, so that it is easier to find or track the results of certain tests, the user may have to edit the test program that causes the test results to be executed. However, this is time-consuming, error prone and inconvenient (and is typically not attempted).

### BRIEF DESCRIPTION OF THE DRAWINGS

Illustrative embodiments of the invention are illustrated in the drawings, in which:

FIG. 1 illustrates an exemplary method for selecting and displaying a number of test data items;

FIGS. 2 & 3 illustrate exemplary variations of the method shown in FIG. 1;

FIG. 4 illustrates an exemplary GUI via which the methods shown in FIGS. 1-3 may be implemented; and

FIGS. 5-7 illustrate exemplary dialog windows that may be launched by the GUI shown in FIG. 4, to facilitate execution of the methods shown in FIGS. 1-3.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

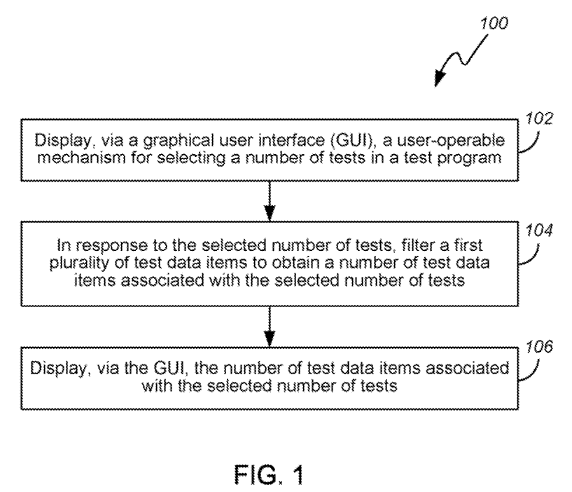

In accord with one embodiment of the invention, FIG. 1 illustrates a computer-implemented method 100. The method 100 comprises displaying, via a graphical user interface (GUI), a user-operable mechanism for selecting a number of tests in a test program. See, block 102. As defined herein, a “number” of something, such as a number of tests, includes “one” or “a plurality” of something (e.g., one or a plurality of tests).

In response to a number of tests that are selected via the mechanism, a plurality of test data items are filtered to obtain a number of test data items associated with the selected tests (at block 104). The number of test data items associated with the selected number of tests is then displayed via the GUI (at block 106).

The test data items that are filtered, and then displayed, may include, for example, both test results and test result identifiers. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the United States patent application of Connally, et al. entitled “Apparatus for Storing and Formatting Data” (Ser. No. 11/345,040).

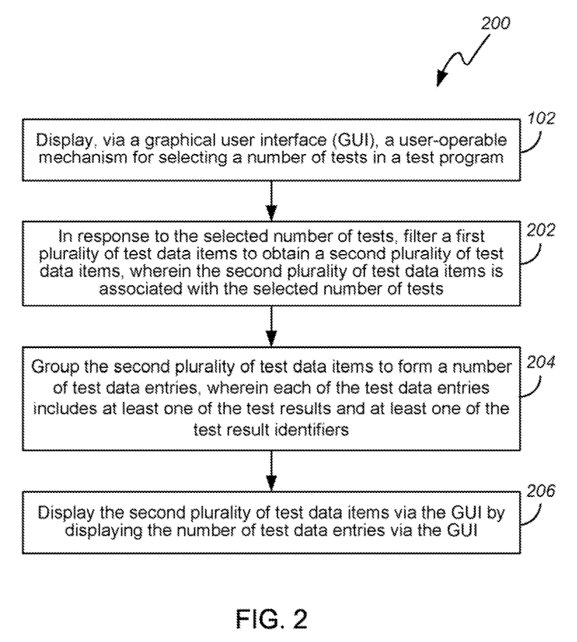

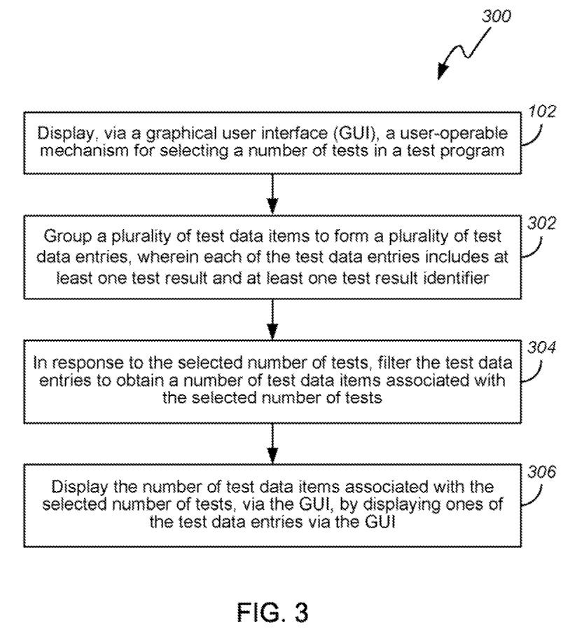

In some embodiments of the method 100 (see, e.g., embodiments 200 and 300, FIGS. 2 & 3), the test data items that are ultimately displayed via the GUI may be grouped to form a number of test data entries, such as test data entries including at least one test result and at least one test result identifier. For example, in the method 200 shown in FIG. 2, a first plurality of test data items may be filtered to obtain a second plurality of test data items (at block 202); ones of the second plurality of test data items may be grouped to form a number of test data entries (at block 204); and the number of test data items associated with the selected number of tests may be displayed by 1) successively displaying the test data entries, or 2) displaying a dynamically updated range of the test data entries (at block 206). Alternately, and as shown in the method 300 (FIG. 3), a plurality of test data items may be grouped to form a plurality of test data entries (at block 302); the plurality of test data items may be filtered by filtering the test data entries (at block 304); and the number of test data items associated with the selected number of tests may be displayed by 1) successively displaying the test data entries, or 2) displaying a dynamically updated range of the test data entries (at block 306).

The methods 100, 200 and 300 are useful, in part, because they enable a user to view test data items (e.g., test results) that are of interest to the user, without the user having to search for the test data items amongst potentially thousands (or more) test data items that are not important to the user.

The methods 100, 200 and 300 shown in FIGS. 1-3 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer-readable code will typically comprise software, but could also comprise firmware or a programmed circuit.

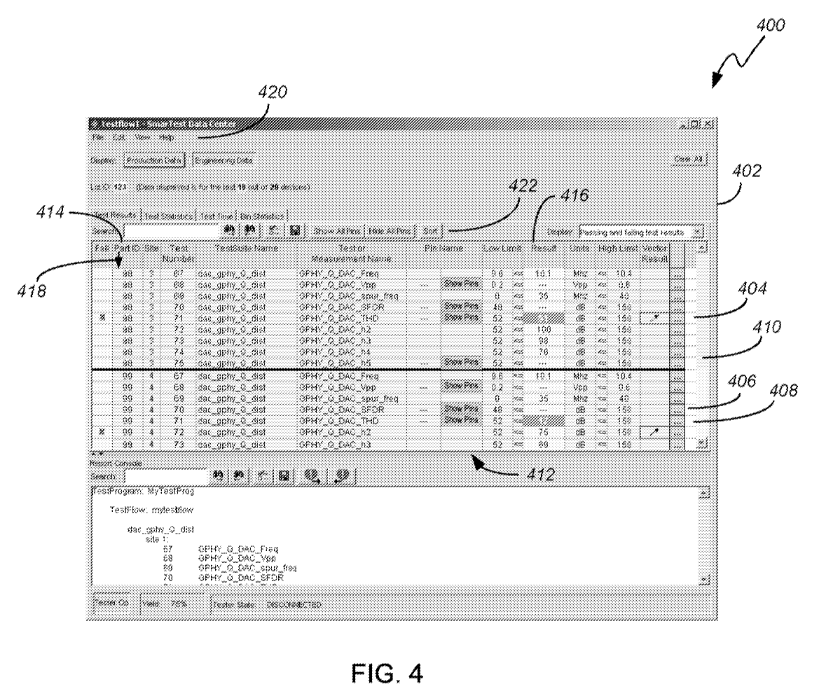

FIG. 4 illustrates an exemplary window (or screen) 402 of a GUI 400 via which any of the methods 100, 200, 300 shown in FIGS. 1-3 may be implemented. As shown, a plurality of test data entries 404, 406, 408 composed of various test data items (such as a “Test Number” and a “Result”) are displayed via the window 402. By way of example, each test data entry 404, 406, 408 comprises three test result identifiers, including: a “Test Number”, a “Test or Measurement Name”, and a “TestSuite Name” that identifies a test suite to which the test name and number belong. In addition, each test data entry 404, 406, 408 comprises: information identifying the test resources via which a test result was acquired (e.g., a test “Site” number), and information identifying the device and pin for which a test result was acquired (e.g., a device “Part ID”, and a device “Pin Name”). Each test data entry 404, 406, 408 also comprises one or more test results, which may take forms such as a value in a “Result” field and/or a check in a “Fail” field (e.g., for those tests that have failed). For measurement type test results, “Unit”, “Low Limit” and “High Limit” fields may also be populated.

Preferably, the window 402 is displayed during execution of a plurality of tests on which the test data entries 404, 406, 408 are based (i.e., during test of a device under test). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 402 (i.e., not in real-time). Typically, the test data entries 404, 406, 408 that are displayed at any one time represent only some of the test data entries or items that are generated during execution of a plurality of tests. One or more mechanisms such as a scroll bar 410 may therefore be provided to allow a user to navigate to different test data entries or items.

As further shown in FIG. 4, each of the test data entries 404, 406, 408 is displayed as a line of a table 412, with different lines of the table corresponding to different ones of the test data entries 404, 406, 408. For purposes of this description, a “table” is defined to be either an integrated structure wherein data is displayed in tabular form, or multiple structures that, when displayed side-by-side, enable a user to review information in rows and columns.

Each of the columns in the table 412 includes a column header, such as the header 414 or the header 416. In one embodiment of the GUI 400, each of the column headers 414, 416 serves as a sort mechanism, and a user's graphical selection of (e.g., click on) one of the headers 414, 416 initiates a re-sort of the test data entries 404, 406, 408, in accord with the test data items referenced by the selected header. In FIG. 4, the test data entries 404, 406, 408 are shown to be primarily sorted by the test data items appearing under the “Part ID” header of the table 412, as indicated by the arrow 418. On a secondary basis, the test data entries 404, 406, 408 shown in FIG. 4 are also sorted chronologically. However, they could also be sorted based on other secondary bases, in accord with test data items appearing under other headers.

In the absence of user input via a sort mechanism (e.g., one of the headers 414, 416), the test data entries 404, 406, 408 may be sorted chronologically, or according to some other default sort order.

If a user highlights or otherwise selects a particular one of the test data entries 404, 406, 408, the table 412 may be “parked” about the particular test data entry. However, if a newly formed test data entry falls within a currently displayed range about the particular test data entry, the displayed range may be dynamically updated to include the newly formed test data entry. In the absence of a user selecting a particular one of the test data entries 404, 406, 408, the range of test data entries 404, 406, 408 displayed in the table 412 may be dynamically updated to include a most recently formed one (or ones) of the test data entries.

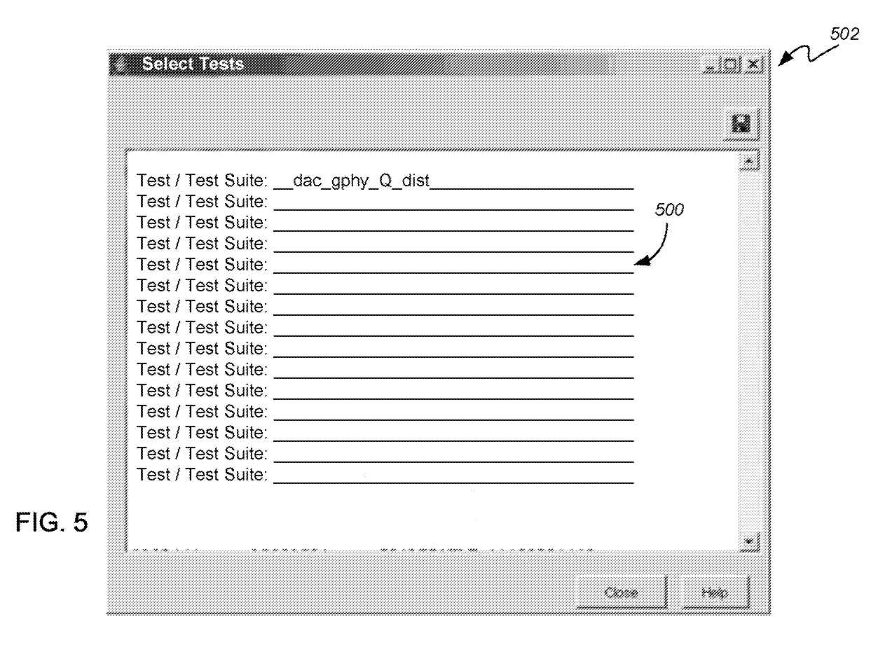

In accord with any of the methods 100, 200 or 300, the GUI 400 may provide a user-operable mechanism for selecting a number of tests in a test program. In one embodiment (FIG. 5), the mechanism may comprise a number of text fields 500 in which a user may type test identifiers such as names or numbers of tests or test suites. A “test suite”, for purposes of this description, is simply a collection of tests. The text fields 500 may be provided via a dialog window 502 of the GUI 400, which dialog window 502 may be launched via a selection on a drop-down menu selected from the menu bar 420 of the window 402.

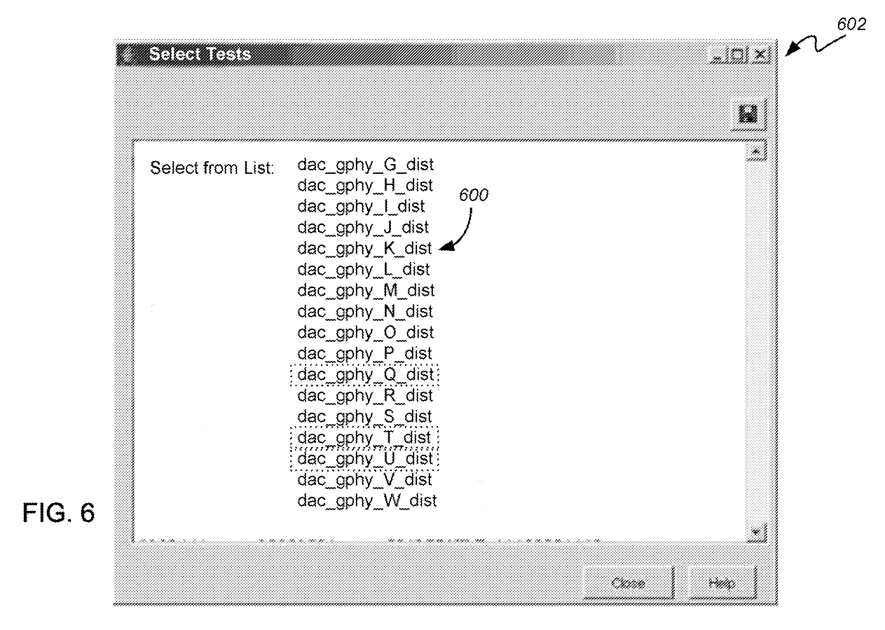

In another embodiment (FIG. 6), the mechanism for selecting a number of tests may comprise a list of test identifiers 600 that are displayed to a user for selection. In some cases, a user may select multiple ones of the test identifiers at once (e.g., by clicking on multiple ones of the test identifiers; or by clicking on multiple ones of the test identifiers while holding a “Shift” key). The list of test identifiers 600 may be compiled as a result of computer-readable code causing a computer to parse a test program and identify the test identifiers. Similarly to the text fields 500 shown in FIG. 5, the list of test identifiers 600 may be displayed via a dialog window 602.

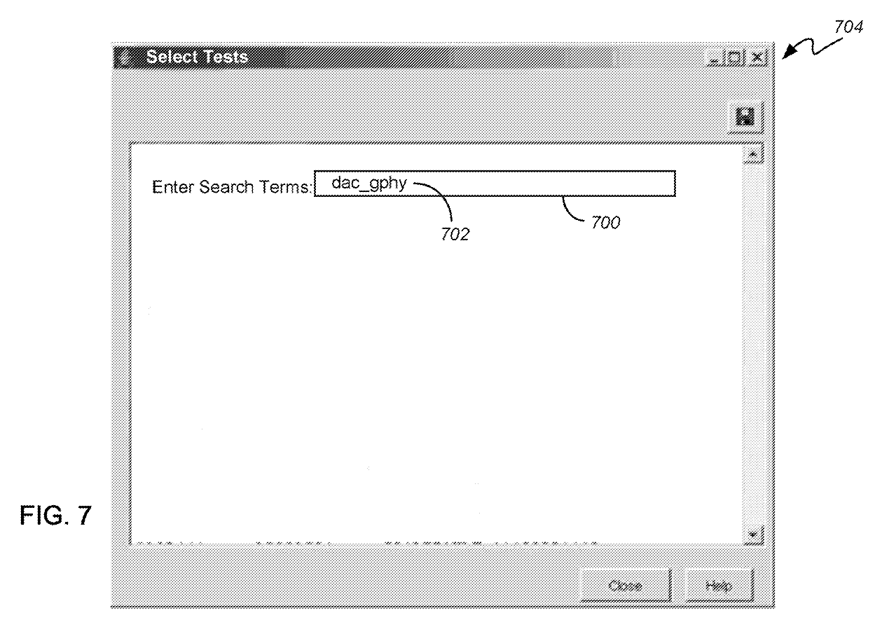

In yet another embodiment (FIG. 7), the mechanism for selecting a number of tests may comprise a search field 700 via which a user may input, for example, part of a test or test suite name or number. The user's input to the search field 700 may then be used to parse the test program and identify the selected number of tests (e.g. based on pattern-matching the user input 702 to parts of test data items). The search field 700 may also be displayed via a dialog window 704.

In still other embodiments, features of the user-operable mechanisms shown in FIGS. 5-7 may be combined, or replaced or supplemented with other user-operable mechanisms for selecting a number of tests that are of interest to a user. Test data items associated with the selected tests may then be displayed via the window 402 of the GUI 400.

Although the dialog windows shown in FIGS. 5-7 may be launched via a pull-down menu selection, they may also be launched in other ways, such as via an icon on the tool bar 422 of the GUI 400. Alternately, the fields 500, 700 or lists 600 of the dialog windows 502, 602, 704 could be provided as parts of the window 402 (i.e., without requiring the launch of a separate dialog window).

What is claimed is:

1. A computer-implemented method, comprising:
displaying, via a graphical user interface (GUI), a user-operable mechanism for selecting a number of tests in a test program;
in response to the selected number of tests, filtering a first plurality of test data items to obtain a number of test data items associated with the selected number of tests; and
displaying, via the GUI, the number of test data items associated with the selected number of tests.

2. The method of claim 1, wherein the number of test data items associated with the selected number of tests is a second plurality of test data items, and wherein the test data items include test results and test result identifiers, the method further comprising:
grouping the second plurality of test data items to form a number of test data entries, wherein each of the test data entries includes at least one of the test results and at least one of the test result identifiers;
wherein displaying the number of test data items associated with the selected number of tests includes displaying a dynamically updated range of the number of test data entries.

3. The method of claim 1, wherein the test data items include test results and test result identifiers, the method further comprising:
grouping the first plurality of test data items to form a plurality of test data entries, wherein each of the test data entries includes at least one of the test results and at least one of the test result identifiers;
wherein the first plurality of test data items are filtered by filtering the plurality of test data entries; and
wherein displaying the number of test data items associated with the selected number of tests includes displaying a dynamically updated range of the test data entries.

4. The method of claim 1, wherein the number of test data items associated with the selected number of tests is a second plurality of test data items, and wherein the test data items include test results and test result identifiers, the method further comprising:
grouping the second plurality of test data items to form a number of test data entries, wherein each of the test data entries includes at least one of the test results and at least one of the test result identifiers;
wherein displaying the number of test data items associated with the selected number of tests includes successively displaying the number of test data entries.

5. The method of claim 1, wherein the test data items include test results and test result identifiers, the method further comprising:
grouping the first plurality of test data items to form a plurality of test data entries, wherein each of the test data entries includes at least one of the test results and at least one of the test result identifiers;
wherein the first plurality of test data items are filtered by filtering the plurality of test data entries; and
wherein displaying the number of test data items associated with the selected number of tests includes successively displaying ones of the test data entries.

6. The method of claim 1, wherein the user-operable mechanism for selecting the number of tests is a number of text fields.

7. The method of claim 1, further comprising:
parsing the test program to compile a list of test identifiers; and
displaying the test identifiers via the GUI, for selection via the user-operable mechanism for selecting the number of tests.

8. The method of claim 7, wherein the test identifiers include test suite identifiers.

9. The method of claim 1, wherein the user-operable mechanism includes a search field, the method further comprising:
using input to the search field to parse the test program and identify the selected number of tests.

10. Apparatus, comprising:
computer-readable media;
computer-readable code, stored on the computer-readable media, including,
code to cause a computer to display, via a graphical user interface (GUI), a user-operable mechanism for selecting a number of tests in a test program;
code to, in response to the selected number of tests, cause the computer to filter a first plurality of test data items to obtain a number of test data items associated with the selected number of tests; and
code to cause the computer to display, via the GUI, the number of test data items associated with the selected number of tests.

11. The apparatus of claim 10, wherein the number of test data items associated with the selected number of tests is a second plurality of test data items, and wherein the test data items include test results and test result identifiers, the apparatus further comprising:
code to cause the computer to group the second plurality of test data items to form a number of test data entries, wherein each of the test data entries includes at least one of the test results and at least one of the test result identifiers;
wherein displaying the number of test data items associated with the selected number of tests includes displaying a dynamically updated range of the number of test data entries.

12. The apparatus of claim 10, wherein the test data items include test results and test result identifiers, the apparatus further comprising:
code to cause the computer to group the first plurality of test data items to form a plurality of test data entries, wherein each of the test data entries includes at least one of the test results and at least one of the test result identifiers;
wherein the first plurality of test data items are filtered by filtering the plurality of test data entries; and
wherein displaying the number of test data items associated with the selected number of tests includes displaying a dynamically updated range of the test data entries.

13. The apparatus of claim 10, wherein the number of test data items associated with the selected number of tests is a second plurality of test data items, and wherein the test data items include test results and test result identifiers, the apparatus further comprising:
code to cause the computer to group the second plurality of test data items to form a number of test data entries, wherein each of the test data entries includes at least one of the test results and at least one of the test result identifiers;
wherein displaying the number of test data items associated with the selected number of tests includes successively displaying the number of test data entries.

14. The apparatus of claim 10, wherein the test data items include test results and test result identifiers, the apparatus further comprising:
code to cause the computer to group the first plurality of test data items to form a plurality of test data entries, wherein each of the test data entries includes at least one of the test results and at least one of the test result identifiers;
wherein the first plurality of test data items are filtered by filtering the plurality of test data entries; and
wherein displaying the number of test data items associated with the selected number of tests includes successively displaying ones of the test data entries.

15. The apparatus of claim 10, wherein the user-operable mechanism for selecting the number of tests is a number of text fields.

16. The apparatus of claim 10, further comprising:
code to cause the computer to parse the test program to compile a list of test identifiers; and
code to cause the computer to display the test identifiers via the GUI, for selection via the user-operable mechanism for selecting the number of tests.

17. The apparatus of claim 16, wherein the test identifiers include test suite identifiers.

18. The apparatus of claim 10, wherein the user-operable mechanism includes a search field, the apparatus further comprising:
code to cause the computer to use input to the search field to parse the test program and identify the selected number of tests.
